(19) United States
(12) Patent Application Publication
(10) Pub. No.: US 2020/0139178 A1
(43) Pub. Date: May 7, 2020

(54) APPARATUS AND METHODS FOR BATTERY FIRE SUPPRESSION USING MULTI-PORT EXTINGUISHING AGENT DISTRIBUTION

(71) Applicant: Flexgen Power Systems. Inc., Durham, NC (US)

(72) Inventors: Tony Olivo, Raleigh, NC (US); Pasi Taimela, Wake Forest, NC (US); Robert William Johnson, JR., Raleigh, NC (US); Clifford Thomas Jones, Raleigh, NC (US)

(21) Appl. No.: 16/668,636

(22) Filed: Oct. 30, 2019

Related U.S. Application Data
(60) Provisional application No. 62/755,049, filed on Nov. 2, 2018.
(60) Provisional application No. 62/801,675, filed on Feb. 6, 2019.

(51) Int. Cl. A62C 37/12; A62C 3/16; H01M 2/10; H01M 10/42

(52) U.S. Cl. CPC A62C 37/12; A62C 3/16; H01M 2220/10; H01M 10/4207; H01M 2200/10; H01M 2/1077

(57) ABSTRACT

An apparatus includes a rack including a plurality of vertically-stacked battery shelves and a vertically extending pipe disposed adjacent the rack. The apparatus further includes a plurality of ports fluidically coupled to the pipe and spaced apart along a length of the pipe, respective ones of the ports configured to direct an extinguishing agent from the pipe towards respective ones of the shelves.

### RELATED APPLICATIONS

The present application claims priority to U.S. Provisional Patent Application Ser. No. 62/755,049 entitled APPARATUS AND METHODS FOR FIRE CONTAINMENT OF LARGE BATTERY SYSTEMS, filed Nov. 2, 2018, and to U.S. Provisional Patent Application Ser. No. 62/801,675 entitled APPARATUS AND METHODS FOR PASSIVE FIRE CONTAINMENT OF LARGE BATTERY SYSTEMS, filed Feb. 6, 2019, the disclosure of each of which is incorporated herein by reference in its entirety.

### BACKGROUND

Embodiments of the inventive subject matter relate to fire suppression and, more particularly, to fire suppression in large battery systems.

Grid energy production is rapidly evolving from the use of central power stations to the use of power sources that are more distributed in nature. The development of distributed renewable energy sources (e.g., wind and solar power generation) has created a basic problem relating to the fact that these renewable resources are only available when there is sun or wind. To have a stable grid, there must be a balance where the generation must substantially equal the load. When there is excess generation, the renewable generation must be curtailed, which results in less than maximum generation.

To maximize these renewable generation resources, an energy store, such as a large battery, may be used to store excess generation when load cannot consume all the generation. When the sun and wind fade, the energy stored in the battery can supplement the renewable generation or supply the load when no sun or wind is available. The battery in such a system may be large and include densely packed cells, which by its nature can present a fire hazard.

Installation of these battery systems into buildings or large containers (e.g., shipping containers) can increase the risk of fire and increase difficulties in extinguishing the fire. Difficulty in deploying the extinguishing agent close to the fire can delay controlling the fire which results in greater property damage. There is an additional concern that a re-ignition of the damaged battery pack can occur hours after the initial event.

Numerous battery fires that have been reported and many can be traced to some type of abuse. In some cases, manufacturing defects can weaken the ability of the battery and contribute to the inability to withstand abuse. Examples of abuse include overheating, shock, overcharge and external short circuit. When responding to a battery fire, first responders can be exposed to electrical shock from the remaining intact cells.

When these battery systems are installed into buildings or large containers, it is generally desirable to minimize the footprint in these deployments. The battery modules 120 are typically placed on individual shelves 110 in a battery rack 100 as shown in FIG. 1. The rack 100 typically includes a battery management module that monitors or has access to the voltage and temperature of the cells. This monitoring can provide information about individual cell temperatures, which can be used to gain advance notice of possible or pending events. For example, a rapid rise of the cell temperature approaching 100° C. might create an alarm condition. Once such an event has been confirmed, an extinguishing agent can be deployed, and an operator alert generated.

These risks have led to extensive efforts to address the threat of thermal runaway in Li-ion battery systems. Proposed responses include the use of copious amounts of water to address this threat.

### SUMMARY

Some embodiments of the inventive subject matter provide an apparatus including a pipe configured to extend adjacent at least one rack having a plurality of vertically stacked battery shelves and at least one plurality of ports fluidically coupled to the pipe, respective ones of the ports configured to direct an extinguishing agent from the pipe towards respective ones of the shelves. The ports may include respective nozzles longitudinally spaced along the pipe. In some embodiments, the pipe may be a vertically-oriented pipe disposed adjacent a side or a corner of the at least one rack.

In some embodiments, the ports may be selectively controllable. For example, the ports may be individually heat-activated. In some embodiments, for example, the apparatus may include respective sprinkler heads coupled to the pipe, each of the sprinkler heads including a nozzle, a member configured to obstruct the nozzle in a first position and to expose the nozzle in a second position, and an actuator configured to move the member from the first position to the second position responsive to heat. The member may include a pivoting arm, the actuator may include a heat-sensitive member that holds the pivoting arm such that the pivoting arm obstructs the nozzle when the heat sensitive member is intact, and the heat-sensitive member may be configured to deform responsive to heat to release the pivoting arm and expose the nozzle.

In further embodiments, the apparatus may further include a monitor circuit configured to detect a pressure drop in the pipe.

In some embodiments, an apparatus includes a rack including a plurality of vertically-stacked battery shelves and a vertically extending pipe disposed adjacent the rack. The apparatus further includes a plurality of ports fluidically coupled to the pipe and spaced apart along a length of the pipe, respective ones of the ports configured to direct an extinguishing agent from the pipe towards respective ones of the shelves.

Still further embodiments provide methods including positioning a pipe adjacent at least one rack having a plurality of vertically stacked battery shelves and directing an extinguishing agent from respective ones of ports fluidically coupled to the pipe towards respective ones of the shelves.

### BRIEF DESCRIPTION OF THE DRAWINGS

FIG. 1 illustrates a battery rack.

FIG. 2A illustrates an extinguishing agent delivery pipe (EADP) according to some embodiments.

FIG. 2B illustrates a port of the EADP of FIG. 2A.

FIG. 3 illustrates examples of positioning of the EADP of FIGS. 2A and 2B in relation to a battery shelf according to some embodiments.

FIG. 4 illustrates an example EADP in relation to two adjacent battery shelves according to some embodiments.

FIG. 5 illustrates an example EADP in relation to four adjacent battery shelves according to some embodiments.

FIG. 6 illustrates a sprinkler head assembly for an EADP according to some embodiments.

FIGS. 7A and 7B illustrate a pattern plug nozzle for use in with an EADP according to some embodiments.

FIG. 8 illustrates a battery shelf configuration for use with an EADP according to some embodiments.

FIG. 9 illustrates a battery system with an integrated fire suppression system according to some embodiments.

FIG. 10 illustrates an EADP with a pressure monitoring circuit according to some embodiments.

FIG. 11 is a view of a battery tray for a battery module rack according to some embodiments.

FIG. 12 is a top view of the battery tray of FIG. 11.

FIG. 13 is a cross-section view of the battery tray of FIG. 11 illustrating battery tray drain according to some embodiments.

FIG. 14 is a side view of a plug for the battery tray drain of FIG. 13.

FIG. 15 is a view of battery rack according to further embodiments.

FIG. 16 is a top view of a battery tray for use in the battery rack of FIG. 15.

FIG. 17 illustrates extinguishing agent flow in the battery rack of FIG. 15.

FIG. 18 illustrates a battery tray arrangement according to further embodiments.

FIG. 19 illustrates a battery system with an integrated fire suppression system according to some embodiments.

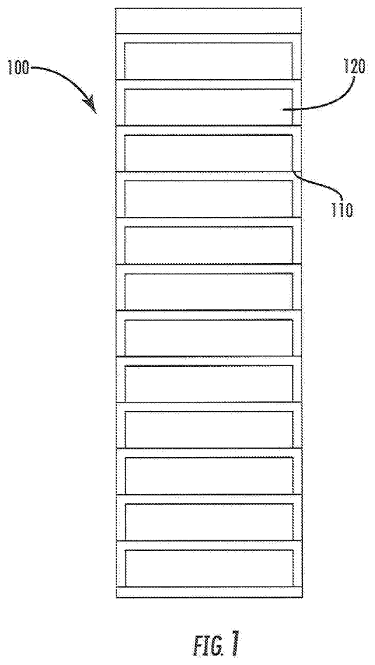

### DETAILED DESCRIPTION

Specific exemplary embodiments of the inventive subject matter will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like items. It will be understood that when an item is referred to as being “connected” or “coupled” to another item, it can be directly connected or coupled to the other item or intervening items may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, items, and/or components, but do not preclude the presence or addition of one or more other features, integers, steps, operations, items, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

As noted above, conventional solutions to fire suppression in large battery systems include using copious amounts of water or other extinguishing agents to suppress the fire. However, conventional approaches can be less effective than desired because they do not distribute extinguishing agent effectively to the fire. For example, if an extinguishing agent is only deployed at the top of a battery rack, battery modules above the fire can block the extinguishing agent from the reaching the fire directly.

The amount of extinguishing agent can be significantly reduced and be more effective if it can be delivered early and at or near the origin of the fire which in turn reduces the extent of the damage to property. Risk can be mitigated by an intelligent set of safety systems that detect and direct the extinguishing agent near to the fire origin to cool it and provide a thermal barrier to adjacent battery modules that will prevent cascading failures.

The effective extinguishing agent should be able to knock down the flame and cool the fuel so it will not ignite the remaining fuel. Tests have shown that water is one of the best agents due to its ability to cool. However, a challenging aspect of a battery fire can be the densely-packed nature of the heat source and the associated inability to direct extinguishing agent on or near the fire.

Some embodiments of the inventive subject matter can provide workable solutions to the above-mentioned challenges by delivering the extinguishing agent closer to the source of the fire and providing a thermal curtain that can prevent batteries adjacent a first from reaching a temperature where they can become involved in the fire.

Using battery rack structures according to some embodiments of the inventive subject matter, extinguishing agent can be delivered closer to a fire in an individual battery module located in the battery rack. Some embodiments can reduce or eliminate the need to provide an extinguishing agent delivery pipes or spray nozzles within the battery rack assembly. Battery racks according to some embodiments may be placed under a standard fire sprinkler head and when sprinkler is activated, the water will be collected near the top of the rack and distributed to each battery tray within the battery rack.

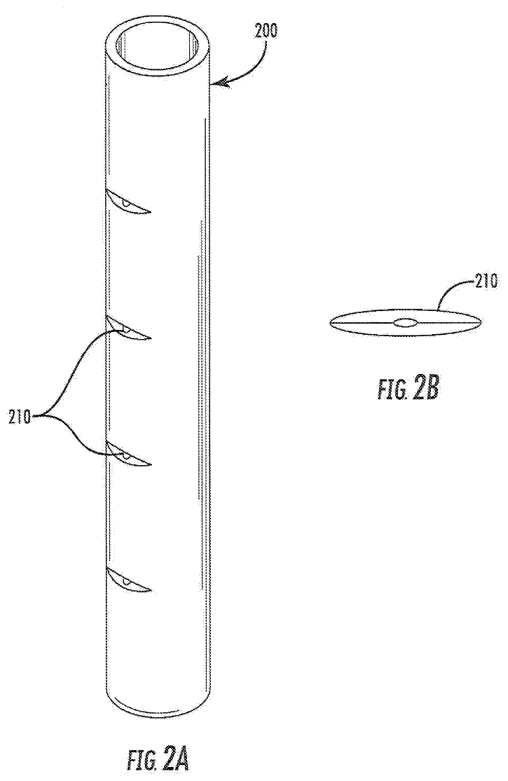

FIGS. 2A and 2B illustrate apparatus and operations for distributing an extinguishing agent closer to a fire in such a battery rack according to some embodiments of the inventive subject matter. An extinguishing agent delivery system, here shown as an extinguishing agent delivery pipe (EADP) 200, may be located adjacent a side or rear face of the battery rack. The EADP 200 may include ports 210 spaced apart at respective locations corresponding respective battery shelves of the battery rack.

The EADP 200 includes a hollow column having respective ports 210 in its walls. Although the EADP 200 is illustrated as a cylindrical, it will be appreciated that an EADP may take other form factors, such as a pipe, column, conduit or similar structure with a polygonal (e.g., triangular, rectangular, hexagonal, etc.), elliptical or other cross section. The vertically spaced ports 210 may provide extinguishing agent more effectively to the individual battery shelves of a rack, and may provide a flat spray that both cools the battery on fire and also creates a thermal shield (i.e., a wall of extinguishing agent) that can reduce heating of a battery sitting on the shelf above the fire. The ports may for example, be machined into a wall of the EADP 200 or may be nozzles configured to be installed in threaded openings in the EADP 200. FIG. 2B illustrates an example port 210, while FIG. 3 illustrates example positions of an EADP 200 adjacent a battery rack 100.

A lip on the underside of the battery tray can deflect the extinguishing agent back onto the fire and help contain the extinguishing agent in the fire area. An EADP, such as the EADP 200, may operate such that no extinguishing agent is in the pipe until the fire event is detected, upon which a valve is opened to fill the pipe and force extinguishing agent through the ports of the EADP. When this occurs, extinguishing agent is directed through all ports of the EADP and provided to all batteries, whether or not they are actively involved in the fire event. This can be cost-effective deployment but can result in substantial unnecessary damage and an unduly expensive cleanup, since all the batteries are exposed to extinguishing agent.

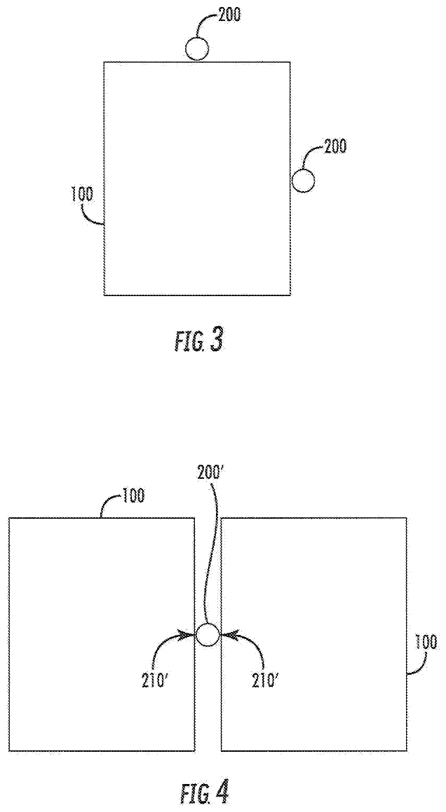

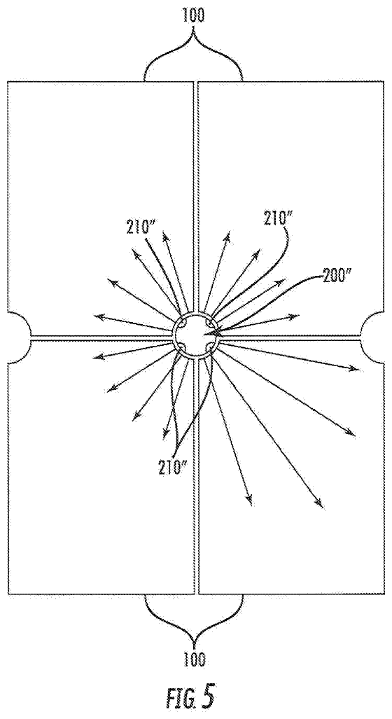

Some embodiments may employ a single EADP that has extinguishing agent delivery ports that face multiple battery racks. For example, FIG. 4 illustrates an EADP 200′ with ports 210′ on opposite sides (180 degrees apart) of the EADP 200′ that face different racks 100 of battery modules. This can be used, for example, for side by side or back to back arrangements of battery racks.

As shown FIG. 5, in some embodiments, a single EADP 200″ may be used to provide extinguishing agent at corners of multiple battery racks 100. The corners of the battery racks 100 can be configured to allow the extinguishing agent ports 210″ of the EADP 200″ to spray into the battery modules either through holes or other openings at the rack corners. In the illustrated embodiments, an EADP 200″ may have four sets of extinguishing agent delivery ports 210″ to provide extinguishing agent to respective ones of four adjacent battery racks.

It will be appreciated that, although the above-described embodiments utilize a vertical EADP, further embodiments may employ other arrangements. For example, instead of one or more vertical EADPs, some embodiments may use respectively horizontally oriented pipes, conduits, etc., that are located at respective shelf levels of multiple adjacent battery racks.

The previous examples show systems that deliver extinguishing agent to all battery modules in a rack or group of racks. According to further embodiments, fire suppression systems and methods may selectively provide extinguishing agent to locations where it is needed. For example, heat-controlled valves can be used at each of the extinguishing agent delivery ports to deliver extinguishing agent only when a sensor mechanism is activated. For example, some embodiments may use a heat sensitive glass capsule similar to those found in conventional fire sprinkler heads to activate an EADP port. Such a configuration can provide a more controlled delivery of extinguishing agent that can be more effective in extinguishing and preventing cascading failures that involve additional battery modules and create collateral damage.

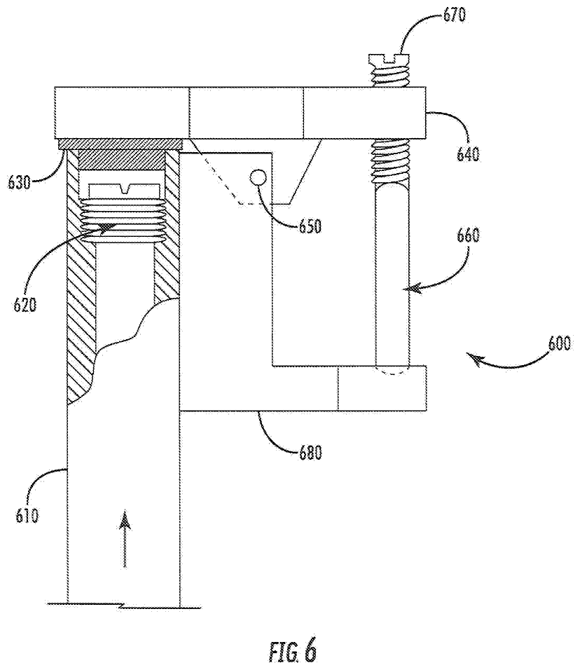

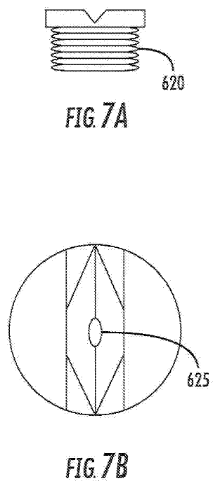

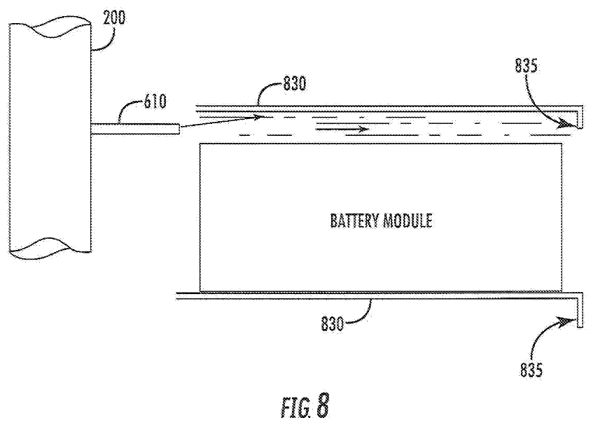

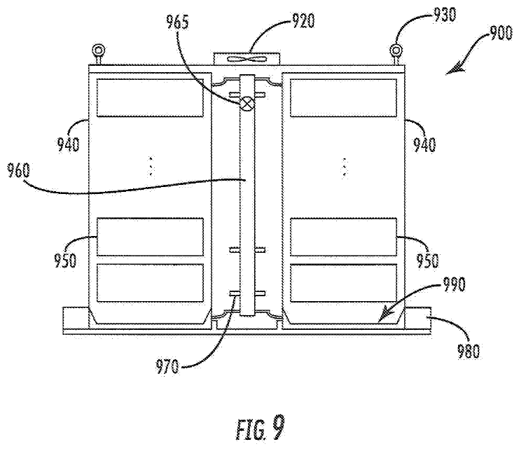

FIG. 6 illustrates an example of such a heat-controlled valve assembly. The assembly 600 includes an extinguishing agent tube 610 which may extend horizontally from a vertical EADP similar to that illustrated in FIG. 3. In an inactive state, an end of the extinguishing agent tube 610 is covered by a rubber seal 630 held in place by a first end of a rocker arm 640. The rocker arm is pivotally 650 attached to the extinguishing agent tube 610 by a frame 680. The second end of the rocker arm 640 rests on the first end of a glass tube 660. The second end of the glass tube 660 rests on a shelf of the frame 680 supported by the extinguishing agent tube. The second end of the rocker arm 640 may have a bore dimensioned to receive a compression member or screw 670 which applies force on the rubber seal 630 through the rocker arm 640. When the material in the glass tube 660 is exposed to heat, an expandable material inside the glass tube 660 causes the tube 660 to shatter or crack, freeing the end of rocker arm 640 and allowing the rubber seal 630 to be expelled from the tube 610 such that the extinguishing agent is delivered from the tube 610 to the area of high temperature to cool the involved battery pack. Interchangeable nozzles 620 can be used in the extinguishing agent tube 610 to provide an extinguishing agent pattern of choice. If a plug similar to the plug 620 illustrated in FIGS. 7A and 7B is used, a flat spray pattern may be produced from opening 625. In addition, barriers 835 could be provided in battery shelves 830 to substantially contain the extinguishing agent within the involved area, as shown in FIG. 8. It will be further appreciated that other types of mechanisms may be used to selectively provide extinguishing agent from EADP ports. For example, some embodiments may use nozzles controlled by electromechanical, magnetic, pneumatic or other mechanisms.

Some embodiments may use similar techniques with dry extinguishing agents. In such cases, after a fire is detected, only the battery pack areas that have experienced excessive heat would deliver the extinguishing agent to the battery minimizing the extent of collateral damage. Alternately, the EADP can be pressurized with a gas and monitored. In the event that there is a loss of pressure in the EADP, an alarm could be sounded, and an operator manually commands to deliver the extinguishing agent through the EADP. Such a system can be used to detect a fire since the capsule would only break if there was excessive heat in that location. For example, a resulting pressure loss could be detected and, responsive to detecting the pressure loss, automatic delivery of the extinguishing agent through the EADP could be initiated. In some embodiments, a pressure drop in the EADP pipe could be monitored, with the magnitude of the drop being used to indicate whether a significant thermal event is occurring.

It may not be cost effective to assemble a large and packed battery system on site. Rather, it may be desirable to build the system in subassemblies and then transport the subassemblies to the site, such that the factory-built subassemblies can be interconnected with a simplified interconnection system. This fabrication approach can reduce or eliminate the need for skilled labor during the interconnection of the subassemblies at the site.

Embodiments of the inventive concepts can be integrated into these factory-built modules, along with other features that may be required at the site, such as seismic anchors, site connections for the EADP, wireways, plenums, etc. These features can be accessed without undue disassembly of the factory-built subassemblies, such as removal of one or more battery trays to access/secure subassembly in seismic zones that might be required in conventional construction.

As illustrated in FIG. 9, the factory-built subassemblies 900 can have integrated fire suppression and other features so that, assembly time and labor is minimized when installed at a site (e.g., placed side-by-side or stacked). For example, such battery systems may be deployed in a container or assembled on a concrete slab without removing or partially disassembling the battery rack to, for example, meet seismic zone requirements. In the subassemblies, for example, the lowest battery modules 950 may be elevated above the bases of the battery racks 940 to allow easy access to anchors for mounting the base plates of the racks to a floor or slab. This may also permit other features to be added below the battery modules 950, such as wireways 980 and/or catch basins 990 and drains for collecting and discharging the extinguishing agent from the bottom of the battery racks. When such subassemblies are stacked or placed side-by-side, they can also form air plenums to enhance cooling of the battery racks. For example, as shown in FIG. 9, a plenum may be formed by the back-to-back battery racks 940 and a fan 920 placed above the plenum may exhaust hot air collected in the plenum.

Such subassemblies can be positioned using, for example, lifting eyes 930 at the top of the assembly 900. Multiple subassemblies may be placed side-by-side to form a battery system. At the end of a row of such subassemblies, a combiner box or similar structure may be placed to provide a common point of connection for the battery racks and a point of connection to the site electrical infrastructure. Installation of the subassemblies may define wireways that facilitate wiring and access to the combiner box. The integrated EADP 960 in the submodules can also reduce the number of on-site extinguishing agent connections required. For example, each subassembly may have a flexible connection to allow adjacent subassemblies to be connected to one another (e.g., in a daisy chain manner) and/or to site-based extinguishing agent infrastructure, such as standpipes. For example, in applications in which multiple battery rack subassemblies are integrally housed in an enclosure such as a shipping container, firefighters may connect a firehose to a connection outside of the shipping container (not shown) that is connected to the main extinguishing agent input port 965 of the factory-built subassemblies 900 to provide an immediate and desirable distribution of extinguishing agent to the battery racks inside via the EADP(s) 960 in the housing and connected extinguishing agent tubes 970. This can relieve the firefighters of the challenge of manually creating the desired flow pattern, reduce delays in extinguishing the fire and reduce dangers to the firefighters associated with opening the housing and/or attempting to disassemble the battery racks to gain access to the burning portions of the assembly. Similar modularized interconnections can be used for fire sensing or control within the subassemblies.

Such modular subassemblies can provide effective solutions for provision of extinguishing agent at the origin of a fire and can also reduce collateral damage from the extinguishing agent. Further embodiments provide integrated subassemblies for constructing complete battery systems that can reduce installation costs and the need for skilled labor on site.

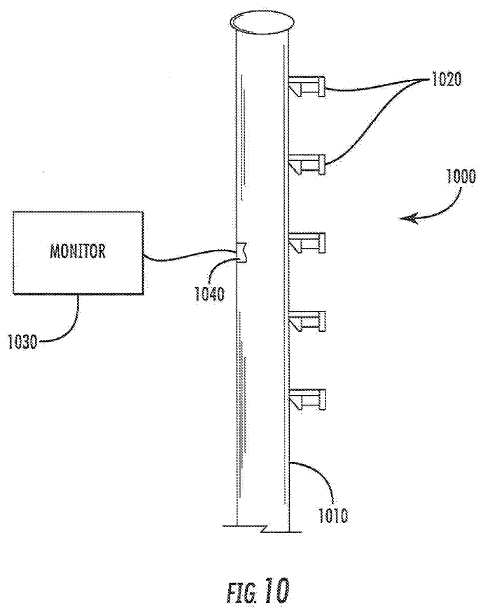

According to additional embodiments, an EADP along the lines described above with reference to FIGS. 6-8 may also be used to detect thermal abnormalities in a battery system. Referring to FIG. 10, an EADP 1000 may include a plurality of heat-activated extinguishing agent ports 1020 distributed on a hollow column 1010, which may operate similar to the port illustrated in FIG. 6. A pressure sensor 1040 may be configured to sense a pressure in the EADP 1000 and responsively provide a sensor signal to a monitor circuit 1030. Responsive to detecting a change in pressure in the EADP 1000 caused by activation of one or more of the extinguishing agent ports 1020, the monitor circuit 1030 may generate an indication of the pressure drop. For example, the monitor circuit 1030 may generate an alarm to signal the occurrence of an undesirable thermal event. As noted above, different signals may be generated based on the magnitude of the detected pressure drop indicating relative severity of the thermal event.

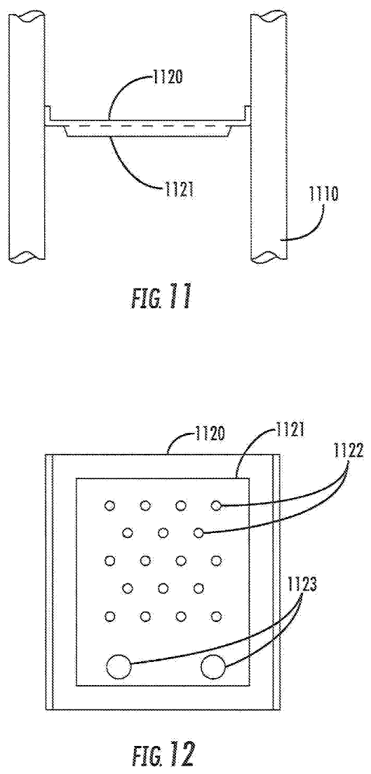

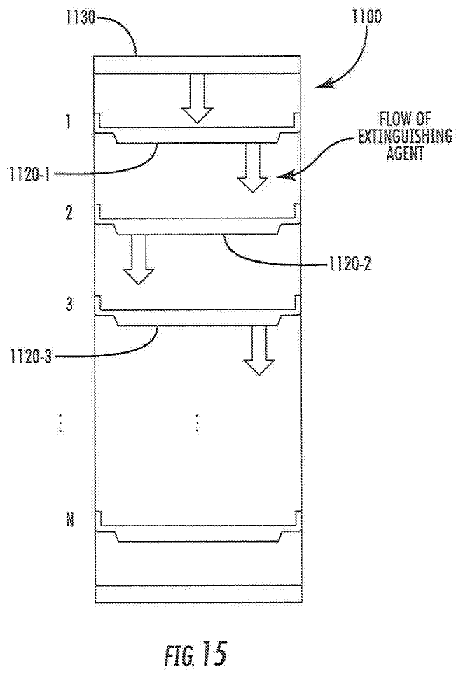

Fire suppression systems for battery racks according to further embodiments will now be discussed with reference to FIGS. 11-19. Referring to FIGS. 11 and 15, each battery module (not shown) is supported by a shelf 1120 (or a pair of L-shaped brackets) attached to vertical support posts 1110 of a battery rack 1100. The battery module shelf 1120 includes a depression 1121 located generally under the center of the battery module. The depression 1121 can have a range of depths. As shown in FIG. 12, the shelf 1120 may have several drain holes 1122 formed in the depression 1121. The drain holes 1122 may be distributed so that extinguishing agent falling from the drain holes will be directed to high risk portions of a battery below the shelf 1120. Extinguishing agent falling on the battery below will collect in a similar shelf supporting the battery below and will, in turn, fall through this shelf onto another underlying battery. The process can be repeated throughout a rack of batteries supported by respective shelves of the type shown in FIGS. 11 and 12.

Although this structure can distribute extinguishing agent to all batteries in the rack, the time to get extinguishing agent to the lower batteries may be significantly delayed. To enhance the delivery of extinguishing agent to the lower batteries, the shelf 1120 can further include bypass (e.g., overflow) paths that allow excess extinguishing agent to fall to the shelf (or shelves) below when the overlying shelf contains a certain level of extinguishing agent. This can accelerate the distribution of extinguishing agent among the trays in the battery rack. Referring to FIG. 12, in some embodiments, this bypass flow can be achieved by including left and right overflow holes 1123. Although FIG. 12 shows two overflow holes 1123 located near a front edge of the shelf 1120, different numbers and placements of such overflow holes may be used.

In some embodiments, the overflow holes can be selectively plugged to provide a desired overflow path. For example, referring to FIG. 12, the left and right overflow holes 1123 may be selectively plugged in the shelves 1120 of a battery rack such that, for example, every odd numbered shelf 1120 will have the left overflow hole 1123 plugged and every even numbered shelf 1120 will have the right overflow hole 1123 plugged. In this arrangement, extinguishing agent falling from the overflow hole 1123 of one shelf does not fall directly into an open overflow hole 1123 of an underlying shelf. In some embodiments, different shelves with different arrangements of overflow holes can be alternately arranged in a rack to achieve a similar effect.

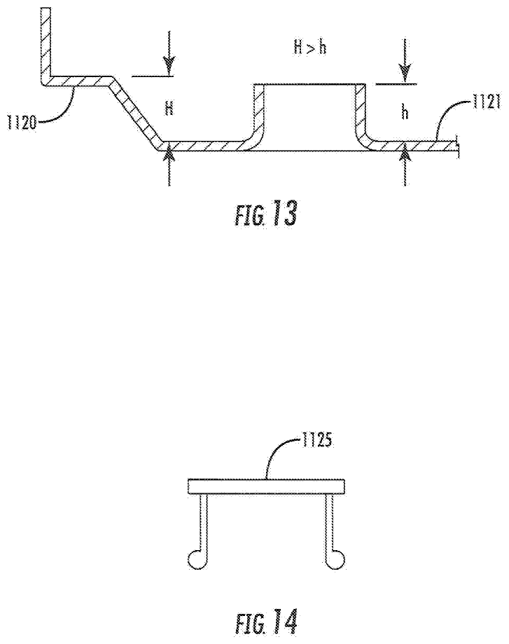

FIG. 13 is a cross-section of an overflow hole according to some embodiments. The depth H of the depression 1121 is greater than the height h of a sidewall of the formed overflow hole 1123. Since the formed overflow hole 1123 has a sidewall with a height that is less than the depth of the depression 1121, the depth of extinguishing agent held in the shelf 1120 can be maintained at or below the height h of the overflow hole 1123. The drain holes 1122 (see FIG. 12) can be sized to drain the shelf 1120 at a desired rate. If the shelf 1120 receives extinguishing agent at a sufficient rate, the depth of extinguishing agent within the depression 1121 can be maintained at the height h of the sidewall of the overflow hole 1123.

FIG. 14 illustrates a snap in plug 1125 that can be used to plug an overflow hole 1123. As noted above, overflow holes 1123 of a stack of shelves 1120 can be selectively plugged such that extinguishing agent does not flow from the overflow hole of one shelf directly into an underlying overflow hole of an underlying shelf. For example, overflow holes that are plugged may be alternated such that a left overflow hole is plugged on odd numbered shelves and a right overflow hole is plugged on the even numbered shelves.

FIG. 15 shows such a “ladder” flow of extinguishing agent down a rack 1100. Extinguishing agent (e.g., water from an overhead sprinkler) collects on top of the rack 1100 and falls down on a first shelf 1120-1 at a location away from the unplugged overflow hole of the first shelf 1120-1. The extinguishing agent collects in the depression of the first shelf 1120-1 until it reaches a height controlled by the height of the sidewall of the open overflow hole of the first shelf 1120-1. Extinguishing agent falling on the first shelf 1120-1 exits by way of the drain holes and overflow hole in the shelf 1120-1, falling on second shelf 1120-2 below. Extinguishing agent falling into the second shelf 1120-2 collects in its depression and falls through its drain holes, with excess agent falling through the overflow hole of the second shelf 1120-2 onto a third shelf 1120-3. As long as there is sufficient extinguishing agent supplied to the rack 1100, extinguishing agent can continue to fill and then overflow each shelf, which can maintain a desired level of extinguishing agent in each shelf, with the drain holes dispersing the extinguishing agent over the batteries held by the shelves.

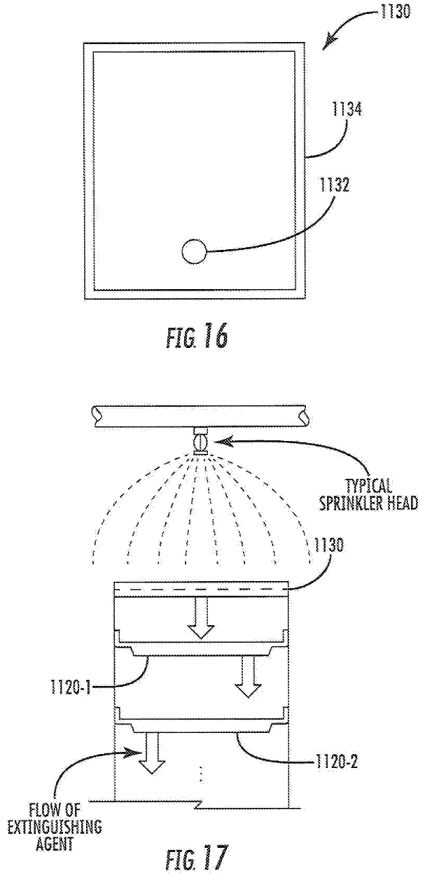

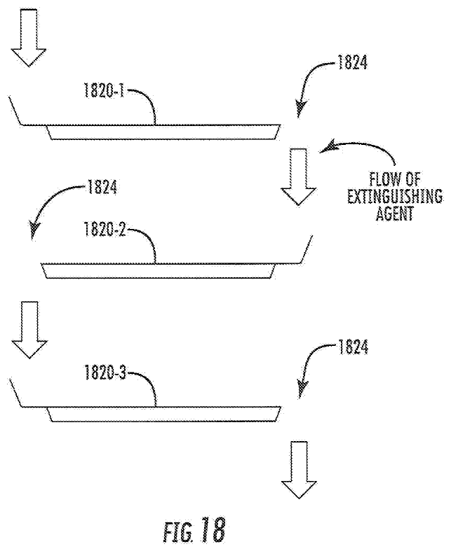

The top of the battery rack 1100 is configured to collect extinguishing agent that falls on the top of the battery rack 1100 and to direct it to the first battery shelf 1120-1 through one or more holes in the top of the battery rack. FIG. 16 shows a top view of the top 1130 of the rack 1100, illustrating that the top 1130 may have a raised perimeter 1134 and at least one top drain hole 1132. It will be appreciated that the top 1130 may also include a plurality of drain holes to disperse extinguishing agent across a battery in the first shelf 1120-1, along the lines illustrated in FIG. 12. FIG. 17 shows an example of how the top 1130 may collect extinguishing agent from a typical sprinkler head. When a fire is detected, the sprinkler head becomes active. For example, the sprinkler head may be part of a dry system where extinguishing agent enters the pipe connected to the sprinkler head after a fire is detected or a wet system where the pipe is pre-filled and the sprinkler head is heat activated. The sprinkler head can provide large amounts of extinguishing agent to the area below it. The top 1130 of the battery rack 1100 collects the extinguishing agent falling on the top of the rack 1100 and discharges it through the top drain hole 1132 to the first shelf 1120-1 below.

Battery racks according to some embodiments allow extinguishing agent to be distributed to multiple tray-like shelves in the battery rack. Such structures can form extinguishing agent barriers of a desired depth at each shelf and disperse a controlled amount of extinguishing agent through the drain holes in each shelf, which in turn falls to the battery below. The thermal barriers can reduce the likelihood that heat from a fire in a given battery pack will excessively raise the temperature of nearby battery modules. The discharge of extinguishing agent from the drain holes can help reduce the temperature of the battery that is on fire and help extinguish the fire. A battery cabinet without such features might prevent extinguishing agent from reaching the origin of a fire located deep in the battery rack.

The size and number of the drain holes can be estimated using volume flow of liquids from a container equation:

The liquid volume flow can be calculated

V=Cd A(2g h)^{1/2}

where

V=volume flow (m³/s)

A=area of aperture-flow outlet (m²)

Cd=discharge coefficient

g=acceleration of gravity (9.81 m/s²)

h=height of fluid above aperture (m)

where

Cd=Cc Cv

Cv=velocity coefficient (water 0.97)

Cc=contraction coefficient (sharp edge aperture 0.62, well rounded aperture 0.97)

For example, height of fluid above the aperture is selected to be 0.00635 m (0.25 inch). The aperture has a sharp-edged hole. This would make Cd equal to 0.62×0.97 or 0.60 for water. The target liquid volume flow is 6.309×10⁻⁵ m³/s (1 gal./minute), thus yielding an aperture area of 0.002972 m² (0.46066 in²). It is generally desirable to distribute the aperture area over a large number of small holes to disperse the extinguishing fluid over battery module located below the shallow tray. Choosing a 0.003175 m (0.125 inch) diameter aperture for the drain hole can yield approximately 38 in a shelf. This pattern of holes can be evenly or selectively distributed to maximize cooling effect on a battery below. The shape, size, number, location and style of the apertures can be selected to provide a desired volume flow and pattern of extinguishing fluid on a battery fire located below the shelf. If extinguishing agent volume flow entering the top of the battery rack is sufficient, the height of extinguishing agent in each shelf can be maintained at the desired height and extinguishing agent delivered to the battery modules below each shelf.

According to further embodiments, another configuration can be provided that facilitates directing the extinguishing agent only on battery modules that have reached elevated temperatures. The extinguishing agent distribution holes of a battery, such as the holes 1122 shown in FIG. 12, may be plugged with a material that has melting point greater than a normal ambient operating temperature for the battery system, but less than a temperature associated with the presence of a fire in an battery module directly below the tray (e.g., a temperature at or near the boiling point of water). While intact, the plug material prevents extinguishing agent from falling on the battery module below but allows the extinguishing agent to accumulate in the shallow depression in the battery shelf. When there is a fire event in a battery module, the heat buildup can cause a melting of the hole plugs for the shelf above the burning battery module. When the water is released from the sprinkler system in response to the detected battery fire, the extinguishing agent fills the trays, but extinguishing agent only flows through the battery tray holes to the battery module below for the tray above the burning battery module. The remaining battery trays fill with extinguishing agent and form thermal barriers to help further protect the undamaged battery modules, but little or no extinguishing agent is dispensed on top of the undamaged battery modules. In the event an additional battery module has a fire event after the release of the extinguishing agent from the sprinkler system, the melting hole plugs above the involved battery module may melt and dispense the extinguishing agent on the involved battery module. In this configuration, the extinguish agent will only flow from holes where the plugs have been melted. This can reduce or minimize damage to unaffected battery modules.

It may not be cost effective to assemble a large and densely-packed battery system on site. Rather, it may be desirable to build the system in subassemblies and then transport the subassemblies to the site. The subassemblies may include battery racks preassembled including battery modules in groups of two or more to reduce installation costs at the customer site. A passive fire containment system along the lines described above can be integrated into such a subassembly, allowing elimination of a need for a direct connection between the building sprinkler systems and the battery rack. Although no direct connection is required, in some embodiments, the sprinkler system at the customer site could also be connected to the rack.

It will be appreciated that, although the above-described embodiments utilize a pattern of drain holes and overflow holes, further embodiments may employ other arrangements. For example, using louvers 1824 on sides of shelves 1820-1, 1820-2, 1820-3 for capturing the extinguishing agent and discharge to the shelf below as shown in FIG. 18 can be used as an alternative to the overflow hole arrangements described above. The depressions in each shelf can provide a thermal barrier of extinguishing agent and discharge of the extinguishing agent to the battery below.

Another configuration that can be used is one in which the sides of the battery support shelves are extended above the bottom surface of the battery pack, which allows the extinguishing agent to collect and partially or completely submerge the battery pack. This arrangement can cause the extinguishing agent to rise to a higher level before falling to the battery shelf below. The battery pack can sit on raised areas of the shelf such that the extinguishing agent can flow under the battery pack while rising to a desired level around the battery pack. Excess extinguishing agent will overflow the sides of the battery support tray to be caught by the battery support tray below. Although full immersion of the battery in extinguishing agent is optimal, it may be impractical to achieve due to features of the battery module, such as fans, power cables and signal connections. The foregoing description of arrangements for dispersing extinguishing agent within the battery rack are examples, and embodiments of the inventive concepts include other mechanical arrangements that combine with one or more of these techniques to provide for a cascading or “ladder” type fall and dispersal of extinguishing agent within a battery cabinet.

Embodiments of the inventive concepts can be integrated into factory-built modules, along with other features that may be required at the site, such as seismic anchors, wireways, plenums, etc. These features can be accessed without undue disassembly of the factory-built subassemblies, such as removal of one or more battery trays to access/secure subassembly in seismic zones that might be required in conventional construction.

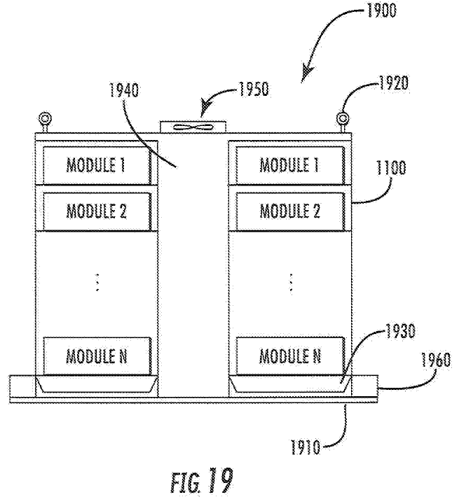

As illustrated in FIG. 19, factory-built subassemblies 1900 including battery racks 1100 can have integrated fire suppression and other features so that assembly time and labor can be reduced when installed at a site (e.g., placed side-by-side or stacked). For example, such battery systems may be deployed in a container or assembled on a concrete slab without removing or partially disassembling the battery racks 1100 to, for example, meet seismic zone requirements. In the subassemblies, for example, the lowest batteries may be elevated above the bases of the battery racks 1100 to allow easy access to anchors for mounting the base plate 1910 of the subassembly 1900 to a floor or slab. This may also permit other features to be added below the battery modules, such as wireways 1960 and/or a catch basins 1930 and drains for collecting and discharging the extinguishing agent from the bottom of the battery racks 1100. As shown in FIG. 19, a plenum 1940 may be formed by the back-to-back battery racks, and a fan 1950 placed above the plenum 1940 may exhaust hot air collected in the plenum 1940. The subassembly 1900 can be positioned using, for example, lifting eyes 1920 at the top of the subassembly.

Multiple subassemblies may be combined to form a battery system. At the end of a row of such subassemblies, for example, a combiner box or similar structure may be placed to provide a common point of connection for the battery racks and a point of connection to the site electrical infrastructure. Installation of the subassemblies may define wireways that facilitate wiring and access to the combiner box. Passive containment systems according to some embodiments of the inventive concepts integrated in the subassemblies can reduce or eliminate the need to make on-site extinguishing agent connections as the subassembly can be placed under a standard sprinkler head(s) to receive extinguishing agent. For example, in applications in which multiple battery rack subassemblies are integrally housed in an enclosure, such as a shipping container, firefighters may connect a firehose to a main extinguishing agent input port accessible at the exterior of the housing to provide an immediate and desirable distribution of extinguishing agent to the battery racks. This can relieve the firefighters of the challenge of manually creating the desired flow pattern, which can reduce delay in extinguishing the fire and reduce danger to the firefighters associated with opening the housing and/or attempting to disassemble the battery racks to gain access to the burning portions of the assembly.

Such modular structures can provide effective solutions for provision of extinguishing agent at the origin of a fire and can also reduce collateral damage from the extinguishing agent. Further embodiments provide integrated subassemblies for constructing complete battery systems that can reduce installation costs and the need for skilled labor on site.

In this specification, there have been disclosed embodiments of the inventive subject matter and, although specific terms are employed, they are used in a generic and descriptive sense only and not for purposes of limitation.

What is claimed:

1. An apparatus comprising:
a pipe configured to extend adjacent at least one rack having a plurality of vertically stacked battery shelves; and
at least one plurality of ports fluidically coupled to the pipe, respective ones of the ports configured to direct an extinguishing agent from the pipe towards respective ones of the shelves.

2. The apparatus of claim 1, wherein the ports comprise respective nozzles longitudinally spaced along the pipe.

3. The apparatus of claim 1, wherein the pipe is disposed adjacent a side or a corner of the at least one rack.

4. The apparatus of claim 1, wherein the ports are selectively controllable.

5. The apparatus of claim 4, wherein the ports are heat-activated.

6. The apparatus of claim 1, wherein the ports comprise respective replaceable nozzles.

7. The apparatus of claim 1, further comprising respective stubs extending from the pipe toward respective ones of the shelves and wherein the ports are disposed proximate ends of the respective stubs.

8. The apparatus of claim 7, further comprising respective sprinkler heads at ends of respective ones of the stubs, each of the sprinkler heads comprising:
a nozzle proximate an end of the stub;
a member configured to obstruct the nozzle in a first position and to expose the nozzle in a second position; and
an actuator configured to move the member from the first position to the second position responsive to heat.

9. The apparatus of claim 8, wherein the member comprises a pivoting arm, wherein the actuator comprises a heat-sensitive member that holds the pivoting arm such that the pivoting arm obstructs the nozzle when the heat sensitive member is intact, and wherein the heat-sensitive member is configured to deform responsive to heat to release the pivoting arm and expose the nozzle.

10. The apparatus of claim 1:
wherein the pipe is configured to extend adjacent a first rack having a first plurality of vertically stacked battery shelves and a second rack adjacent the first rack and having a second plurality of vertically stacked battery shelves; and
wherein the at least one plurality of ports comprises a first plurality of ports configured to direct the extinguishing agent toward respective ones of the first plurality of shelves and a second plurality of ports configured to direct the extinguishing agent toward respective ones of the second plurality of shelves.

11. The apparatus of claim 1, further comprising the at least one rack.

12. The apparatus of claim 11, wherein each of the shelves comprises at least one barrier configured to contain extinguishing agent within the shelf.

13. The apparatus of claim 1, wherein the extinguishing agent comprises a liquid extinguishing agent or a dry extinguishing agent.

14. The apparatus of claim 1, further comprising a monitor circuit configured to detect a pressure drop in the pipe.

15. An apparatus comprising:
a rack comprising a plurality of vertically-stacked battery shelves;
a vertically extending pipe disposed adjacent the rack; and
a plurality of ports fluidically coupled to the pipe and spaced apart along a length of the pipe, respective ones of the ports configured to direct an extinguishing agent from the pipe towards respective ones of the shelves.

16. The apparatus of claim 15, wherein the pipe is disposed adjacent a side or a corner of the rack.

17. The apparatus of claim 15, wherein the ports are configured to be selectively activated responsive to heat.

18. The apparatus of claim 17, wherein the ports comprise respective heat-activated sprinkler heads, each of the sprinkler heads comprising:
a nozzle;
a member configured to obstruct the nozzle in a first position and to expose the nozzle in a second position; and
an actuator configured to move the member from the first position to the second position responsive to heat.

19. The apparatus of claim 18, wherein the member comprises a pivoting member, wherein the actuator comprises a heat-sensitive member that holds the pivoting member such that the pivoting member obstructs the nozzle when the heat sensitive member is intact, and wherein the heat-sensitive member is configured to deform responsive to heat to release the pivoting member and expose the nozzle.

20. A method comprising:
positioning a pipe adjacent at least one rack having a plurality of vertically stacked battery shelves; and
directing an extinguishing agent from respective ones of ports fluidically coupled to the pipe towards respective ones of the shelves.
